(19) United States
(12) Patent Application Publication
(10) Pub. No.: US 2025/0240779 A1
(43) Pub. Date: Jul. 24, 2025

(54) READER-GUIDED TRANSMISSION AND RECEPTION

(71) Applicant: Samsung Electronics Co., Ltd., Suwon-si (KR)

(72) Inventors: Jeongho Jeon, San Jose, CA (US); Ebrahim MolavianJazi, San Jose, CA (US); Aristides Papasakellariou, Houston, TX (US)

(21) Appl. No.: 19/014,126

(22) Filed: Jan. 8, 2025

Related U.S. Application Data
(60) Provisional application No. 63/623,043, filed on Jan. 19, 2024.
(60) Provisional application No. 63/554,021, filed on Feb. 15, 2024.

(51) Int. Cl. H04W 72/121; H04W 72/02; H04W 72/04

(52) U.S. Cl. CPC H04W 72/121; H04W 72/02; H04W 72/04

(57) ABSTRACT

Apparatuses and methods for network guided transmission and reception. A method for an Internet of Things (IoT) device to communicate with a reader includes receiving first one or more physical reader-to-device channels (PRDCHs) from the reader. The first one or more PRDCHs include information related to transmission of a physical device-to-reader channel (PDRCH) including at least one of transmission resources, one or more identifiers corresponding to respective one or more devices, a group identifier corresponding to one or more devices, and no identifier corresponding to all devices receiving the first one or more PRDCHs. The method further includes determining a first PDRCH based on the information in the first one or more PRDCHs, transmitting the first PDRCH to the reader based on the information in the first one or more PRDCHs, and receiving a second PRDCH that includes an acknowledgement of reception of the first PDRCH.

### CROSS-REFERENCE TO RELATED AND CLAIM OF PRIORITY

The present application claims priority under 35 U.S.C. § 119(e) to U.S. Provisional Patent Application No. 63/623,043 filed on Jan. 19, 2024 and U.S. Provisional Patent Application No. 63/554,021 filed on Feb. 15, 2024, which are hereby incorporated by reference in their entirety.

### TECHNICAL FIELD

The present disclosure relates generally to wireless communication systems and, more specifically, the present disclosure is related to apparatuses and methods for reader-guided transmission and reception.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to reader-guided transmission and reception.

In one embodiment, a method for an Internet of Things (IoT) device to communicate with a reader is provided. The method includes receiving first one or more physical reader-to-device channels (PRDCHs) from the reader. The reader is a base station or a user equipment (UE). The first one or more PRDCHs include information related to transmission of a physical device-to-reader channel (PDRCH) including at least one of one or more transmission resources, one or more identifiers corresponding to respective one or more devices, a group identifier corresponding to one or more devices, and no identifier corresponding to all devices receiving the first one or more PRDCHs. The method further includes determining a first PDRCH based on the information in the first one or more PRDCHs and transmitting the first PDRCH to the reader based on the information in the first one or more PRDCHs. The first PDRCH is On-Off Keying (OOK) or Phase-Shift Keying (PSK) modulated by backscattering an externally provided carrier wave (CW) or generating the CW internally. The method further includes receiving a second PRDCH from the reader. The second PRDCH includes an acknowledgement of reception of the first PDRCH.

In another embodiment, an IoT device is provided. The IoT device includes a transceiver configured to receive first one or more PRDCHs from a reader. The reader is a base station or a UE. The first one or more PRDCHs include information related to transmission of a PDRCH including at least one of one or more transmission resources, one or more identifiers corresponding to respective one or more devices, a group identifier corresponding to one or more devices, and no identifier corresponding to all devices receiving the first one or more PRDCHs. The IoT device further includes processing circuitry operably coupled with the transceiver. The processing circuitry is determine a first PDRCH based on the information in the first one or more PRDCHs. The transceiver is further configured to transmit the first PDRCH to the reader based on the information in the first one or more PRDCHs and receive a second PRDCH from the reader. The first PDRCH is OOK or PSK modulated by backscattering an externally provided CW or generating the CW internally. The second PRDCH includes an acknowledgement of reception of the first PDRCH.

In yet another embodiment, a reader is provided. The reader includes a transceiver configured to transmit first one or more PRDCHs to an IoT device. The reader is a base station or a UE. The first one or more PRDCHs include information related to transmission of a PDRCH including at least one of one or more transmission resources, one or more identifiers corresponding to respective one or more devices, a group identifier corresponding to one or more devices, and no identifier corresponding to all devices receiving the first one or more PRDCHs. The transceiver is configured to receive a first PDRCH to the reader based on the information in the first one or more PRDCHs and transmit a second PRDCH from the IoT device. The first PDRCH is OOK or PSK modulated by backscattering of an externally provided CW or internal generation of the CW. The second PRDCH includes an acknowledgement of reception of the first PDRCH.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency-division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a DCI format according to embodiments of the present disclosure;

FIGS. 9A and 9B illustrate diagrams of example type-1 backscatter structures for internet of thing(s) (IoT) devices according to embodiments of the present disclosure;

FIG. 10 illustrates a diagram of an example impedance matching circuit according to embodiments of the present disclosure;

FIGS. 11A and 11B illustrate examples of type-2 backscatter structures for IoT devices according to embodiments of the present disclosure;

FIGS. 12A and 12B illustrate examples of type-2 active structures for IoT devices according to embodiments of the present disclosure;

FIGS. 13A and 13B illustrates timelines for example reader-guided asynchronous systems and different communication modes according to embodiments of the present disclosure;

FIG. 14 illustrates a flowchart of an example procedure for reader-triggered device identification according to embodiments of the present disclosure;

FIG. 15 illustrates a flowchart of an example procedure for reader-triggered device identification according to embodiments of the present disclosure;

FIG. 16 illustrates a timeline for reader-triggered device identification according to embodiments of the present disclosure;

FIG. 17 illustrates a flowchart of an example procedure for reader-triggered communication according to embodiments of the present disclosure;

FIG. 18 illustrates a flowchart for reader-triggered communication according to embodiments of the present disclosure;

FIG. 19 illustrates a timeline for reader-triggered communication according to embodiments of the present disclosure; and

FIG. 20 illustrates a timeline for reader-triggered device-to-reader autonomous transmission according to embodiments of the present disclosure; and

FIG. 21 illustrates an example device ID structure according to embodiments of the present disclosure.

### DETAILED DESCRIPTION

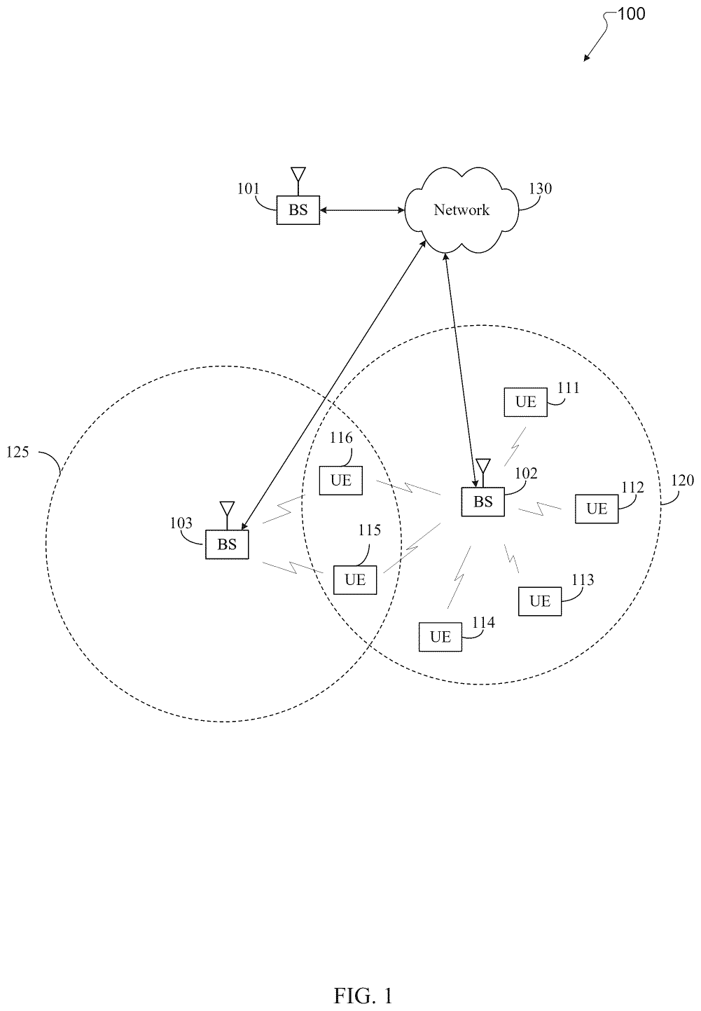

FIGS. 1-21, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1]3GPP TS 38.211 v17.5.0, “NR; Physical channels and modulation;” [2]3GPP TS 38.212 v17.5.0, “NR; Multiplexing and channel coding;” [3]3GPP TS 38.213 v17.6.0, “NR; Physical layer procedures for control;” [4]3GPP TS 38.214 v17.6.0, “NR; Physical layer procedures for data;” [5]3GPP TS 38.331 v17.5.0, “NR; Radio Resource Control (RRC) protocol specification;” and [6]3GPP TS 38.321 v17.5.0, “NR; Medium Access Control (MAC) protocol specification.”

FIGS. 1-3 below describe various embodiments implemented in wireless communications systems and with the use of orthogonal frequency-division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying a reader-guided transmission and reception. In certain embodiments, one or more of the gNBs 101-103 include circuitry, programing, or a combination thereof to provide for reader-guided transmission and reception.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

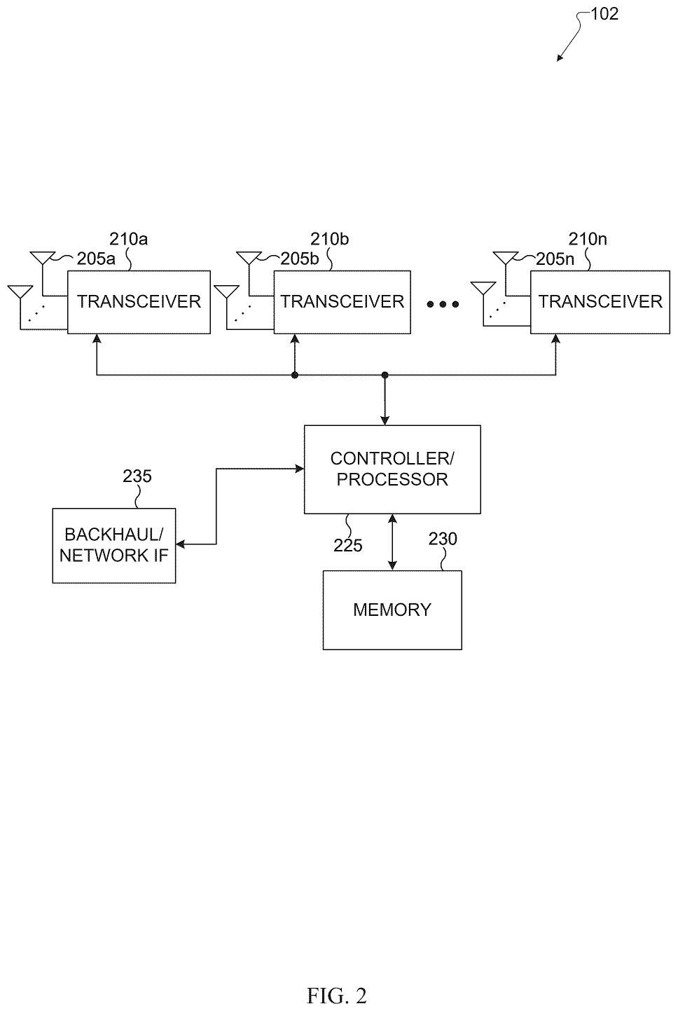

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for reader-guided transmission and reception. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

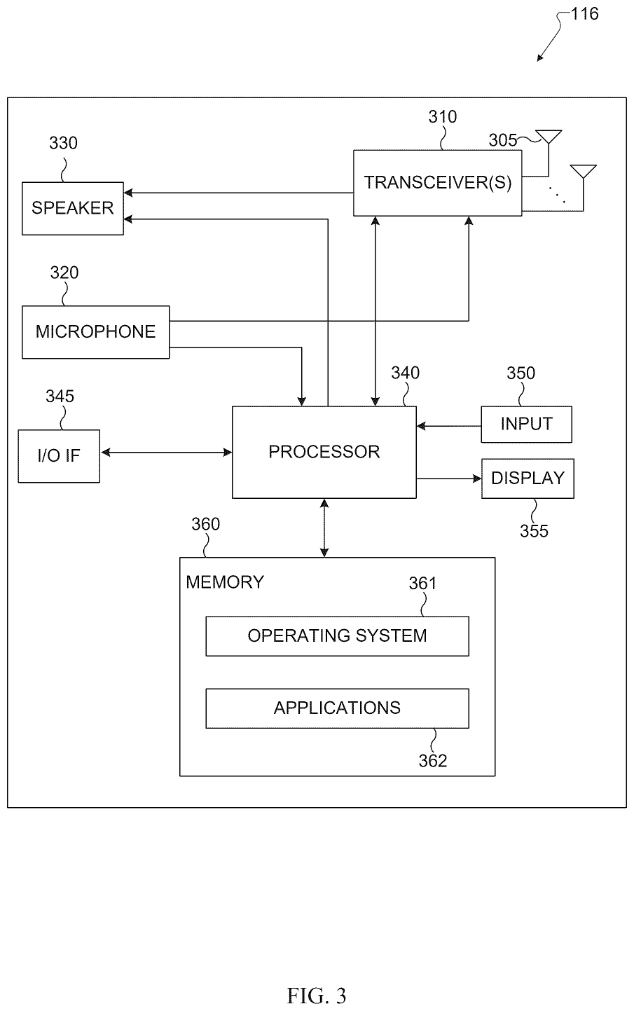

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify reader-guided transmission and reception as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

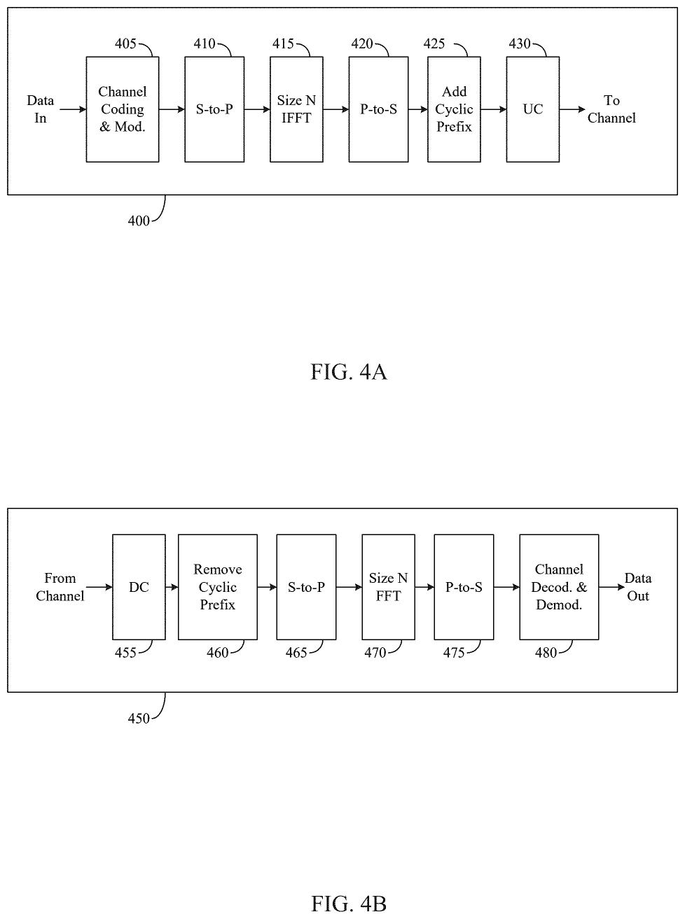

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 perform or utilize reader-guided transmission and reception as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Internet of things (IoT) devices include ambient-power-enabled IoT (A-IoT) devices, which are ultra-low-complexity devices with very small form factor and low-cost design that operate without a common battery that can be manually replaced or recharged. Instead, A-IoT devices can be battery-less or with a small battery (such as a small capacitor) that operate based on energy harvesting from RF waveforms or other ambient energy sources. Regarding the limited size and complexity required by practical applications for battery-less devices with no energy storage capability or devices with limited energy storage that do not need to be replaced or recharged manually, the output power of energy harvester is typically from 1 μW to a few hundreds of μW.

In various embodiments throughout the disclosure, a UE or a device may be referred to as an A-IoT device or an A-IoT UE based on energy harvesting with ultra-low complexity and power consumption and for low-end IoT applications. For example, the UE may have limited (or no) energy storage or battery capability (e.g., a capacitor), such as an energy storage unit for amplification of receptions at the UE or transmission by the UE, or for other UE operations, such as power-on, warm-up, memory, internal processing, and so on, or operating with backscattering communication.

An A-IoT device can be an IoT device that satisfies one or more of the following (or variations thereof):
powered by energy harvesting, being either battery-less or with limited energy storage capability (e.g., using a capacitor) and the energy is provided through the harvesting of radio waves (including RF waveforms), light (including solar light or indoor light), motion, pressure, heat, or any other power source that could be seen suitable;
with low complexity, small size and lower capabilities and lower power consumption than previously defined 3GPP IoT devices (e.g., NB-IoT/enhanced machine type communication (eMTC) devices);
maintenance free and can have long life span (e.g., more than 10 years).

An A-IoT may directly communicate with a base station/gNB (e.g., operating as a reader), or may indirectly communicate with a base station/gNB through an intermediate/assisting node, such as a handheld device/UE (for example, a “reader” UE that scans the A-IoT devices), a relay, integrated access and backhaul (IAB) node, a repeater for example a network-controlled repeater (NCR), and so on. The communication can be mono-static wherein the transmitter node to the A-IoT UE is same as the receiving node from the A-IoT UE, or can be bi-static (or multi-static) wherein the transmitter nodes to the A-IoT UE can be different from the receiving nodes from the A-IoT UE.

In various embodiments, the A-IoT device operates with energy storage and power management capability. These devices are characterized by ultra-low power consumption and they employ energy harvesting mechanisms such as solar, RF energy and kinetic energy and thus don't require battery replacement or swapping frequently. In various embodiments, an A-IoT device operates with energy harvesting (EH) or with limited (or no) energy storage/battery capability (such as a capacitor), such as an energy storage unit for amplification of receptions at the UE or transmission by the UE, or for other UE operations, such as power-on, warm-up, memory, internal processing, and so on, or operating with backscattering communication.

In various embodiments, the A-IoT device operates with RF envelope detection for receiving amplitude shift keying (ASK), e.g., OOK, modulated signal. RF envelope detection is a key function that enables the Ambient IoT devices to filter and analyze RF signals. This technique is applied in the reception of modulated RF signals with a view of acquiring information from the signals and hence enable communication between devices with efficiency and with minimum power consumption. RF envelope detection is one of the most important techniques that are used in many of the low power consumption wireless communication protocols that are employed in Ambient IoT systems.

In various embodiments, the A-IoT device may operate with impedance matching. Impedance matching may be utilized in passive Ambient IoT devices backscattering externally provisioned CW signal.

The disclosure relates to a communication system. The disclosure relates to defining functionalities and procedures for communication with A-IoT devices which may be lacking a precise timing capability and may operate in a passive or an active communication mode.

The disclosure relates to defining functionalities and procedures for A-IoT devices to perform reader-triggered identification process which involve UL random access and collision handling. DL and UL are also referred to as reader-to-device (R2D) and device-to-reader (D2R), respectively, and vice versa.

The disclosure further relates to defining functionalities and procedures for selectively restricting the previously identified UEs accessing the random transmission opportunities again.

The disclosure further relates to defining functionalities and procedures for limiting the set of devices attempting the random access for given random access occasions.

The disclosure further relates to defining functionalities and procedures for A-IoT devices to perform reader-triggered targeted communication mode following the command received from the network (e.g., the network 130).

The disclosure relates to defining functionalities and procedures for A-IoT devices to perform reader-triggered D2R autonomous transmission which involves D2R random access following reader triggering.

The disclosure further relates to defining functionalities and procedures for D2R power control.

The disclosure further relates to defining functionalities and procedures for D2R transmission timing correction.

The disclosure further relates to defining functionalities and procedures for efficiently addressing a subset of devices for groupcast.

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Embodiments of the disclosure for communication with A-IoT devices, which may be lacking a precise timing capability and may operate in a passive communication mode, are summarized in the following and are fully elaborated further herein.
Method and apparatus for defining functionalities and procedures for A-IoT devices to perform reader-triggered identification process which involve D2R random access and collision handling.
Method and apparatus for defining functionalities and procedures for selectively restricting the previously identified UEs accessing the random transmission opportunities again.
Method and apparatus for defining functionalities and procedures for limiting the set of devices attempting the random access for given random access occasions.
Method and apparatus for defining functionalities and procedures for A-IoT devices to perform reader-triggered targeted communication mode following the command received from the network.
Method and apparatus for defining functionalities and procedures for A-IoT devices to perform reader-triggered D2R autonomous transmission which involves D2R random access following reader triggering.
Method and apparatus for defining functionalities and procedures for D2R power control.
Method and apparatus for defining functionalities and procedures for D2R transmission timing correction.
Method and apparatus for defining functionalities and procedures for efficiently addressing a subset of devices for groupcast.

It is envisaged that the number of connected devices will reach ˜500 billion by 2030, which is about ˜59 times larger than the expected world population (˜8.5 billion) by that time. Mobile devices will take various form-factors, such as augmented reality (AR) glasses, virtual reality (VR) headsets, hologram devices, while a large portion of the devices will be Internet-of-Things (IoT) devices for improving productivity efficiency and increasing comforts of life. As the number of IoT devices grows exponentially, those IoT devices will become dominant in the next generation wireless communication systems such as fifth generation (5G) advanced, sixth generation (6G) systems, and so on.

With the explosive number of IoT devices, it may be challenging to power the IoT devices by battery that needs to be replaced or recharged manually, which leads to high maintenance cost. The automation and digitalization of various industries demand new IoT technologies of supporting batteryless devices with no energy storage capability or devices with energy storage that does not need to be replaced or recharged manually. Such types of devices are collectively termed as ambient IoT (A-IoT) in this disclosure, which is powered by various renewable energy sources such as radio waves, light, motion, or heat, etc. Use cases of A-IoT devices (e.g., the IoT device 950) include asset inventory/tracking and remote environmental monitoring. The following list provides example use cases of A-IoT devices:
Indoor inventory
   Automated warehousing
   Medical instruments inventory management and positioning
   Non-Public Network for logistics
   Automobile manufacturing
   Airport terminal/shipping port
   Smart laundry
   Automated supply chain distribution
   Fresh food supply chain
   End-to-end logistics
   Flower auction
   Electronic shelf label
Indoor sensor
   Smart homes
   Base station machine room environmental supervision
   Smart laundry
   Smart agriculture
   Smart pig farm
   Cow stable
Indoor positioning
   Finding Remote Lost Item
   Location service
   Ranging in a home
   Personal belongings finding
   Positioning in shopping center
   Museum Guide
Indoor command
   Online modification of medical instruments status
   Device activation and deactivation
   Elderly Health Care
   Device Permanent Deactivation
   Electronic shelf label
Outdoor inventory
   Medical instruments inventory management and positioning
   Non-public network for logistics
   Airport terminal/shipping port
   Automated supply chain distribution
Outdoor sensor
   Smart grids
   Forest Fire Monitoring
   Dairy farming
   Smart manhole cover safety monitoring
   Smart bridge health monitoring
Outdoor positioning
   Finding remote lost item
   Location service
   Personal belongings finding
Outdoor command
   Online modification of medical instruments status
   Device activation and deactivation
   Elderly Health Care
   Controller in smart agriculture

Taking into account the limited size and low complexity required by practical applications of A-IoT devices, the output power of energy harvesting from ambient power sources is typically from 1 μW to a few hundreds of μW, which is orders of magnitude lower than normal user equipment (UE) having peak power consumption higher than 10 mW. This requires a new wireless access technology for A-IoT devices, which cannot be fulfilled by existing cellular systems including low-power IoT technologies such as NB-IoT and eMTC.

In the following, an italicized name for a parameter implies that the parameter is provided by higher layers.

DL transmissions or D2R transmissions can be based on an OFDM waveform including a variant using DFT precoding that is known as DFT-spread-OFDM that is typically applicable to D2R transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB (e.g., the BS 102) refers to a base station serving UEs operating with NR RAT. Exemplary embodiments evaluate a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for R2D signaling or for D2R signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in 3GPP TS 36.211 [REF1]v17.6.0, “NR; Physical channels and modulation”, and 3GPP TS 38.213 [REF3]v17.6.0 “NR; Physical Layer procedures for control”.

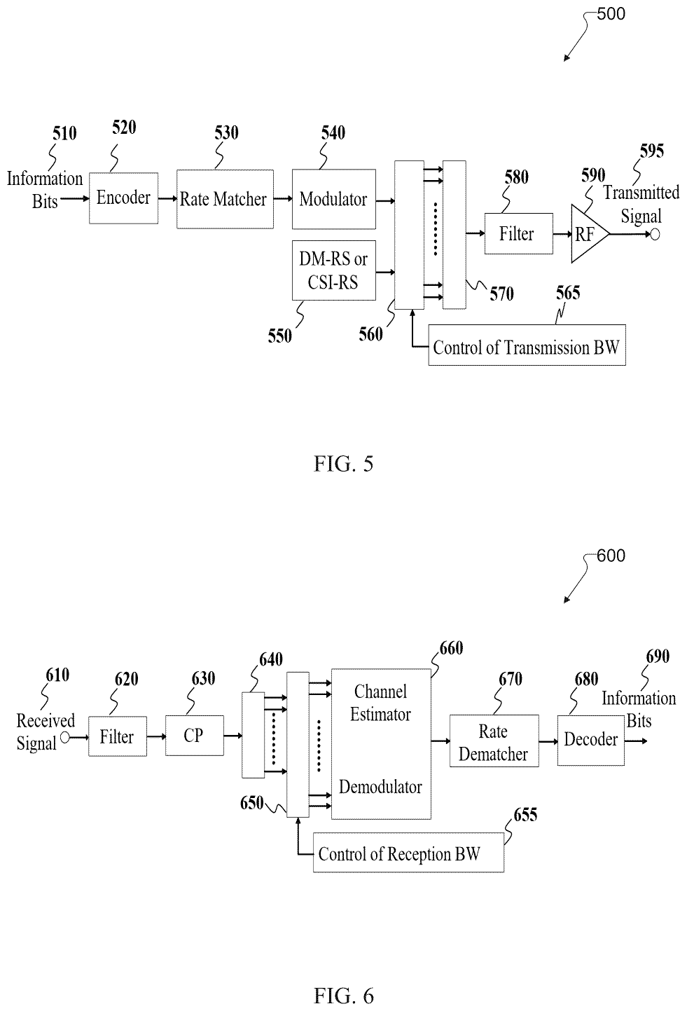

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and DM-RS or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

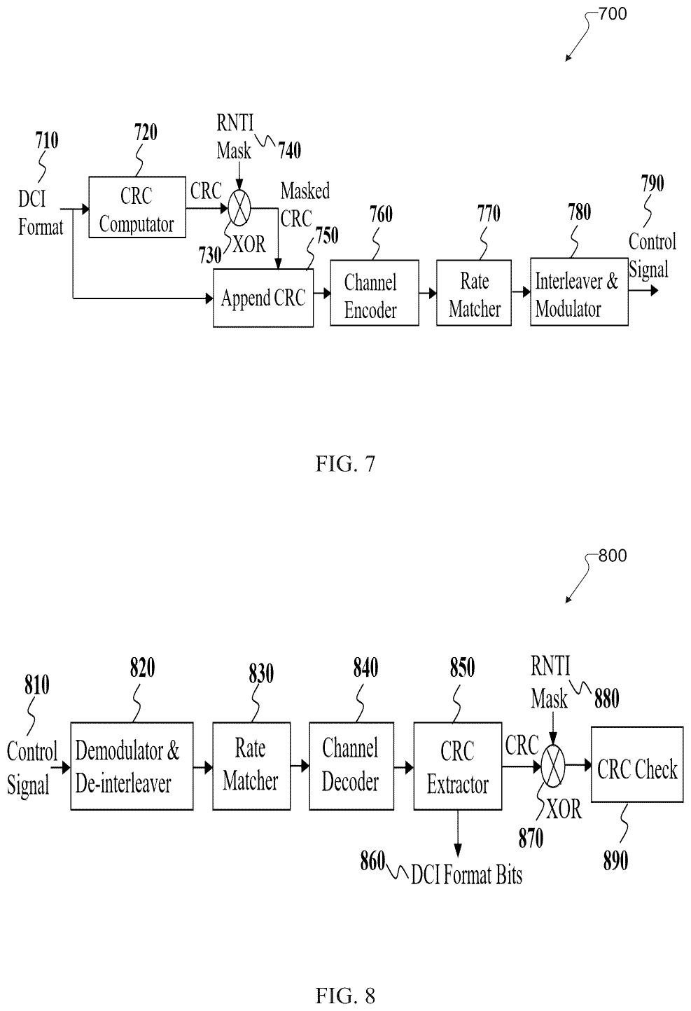

FIG. 7 illustrates an example encoding structure 700 for a downlink control information (DCI) format according to embodiments of the present disclosure. For example, can be implemented in gNB 102 of FIG. 1. This example is for illustration only and other embodiments can be used without departing from the scope of the present disclosure.

A gNB (e.g., the BS 102) separately encodes and transmits each DCI format in a respective PDCCH. When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR(0,0)=0, XOR(0,1)=1, XOR(1,0)=1, XOR(1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

DCI can serve several purposes. A DCI format includes a number of fields, or information elements (IEs), and is typically used for scheduling a PDSCH (DL DCI format) or a PUSCH (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with RRC connection to a gNB, the RNTI is a cell RNTI (C-RNTI) or another RNTI type such as a modulation and coding scheme-cell RNTI (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a TPC-RNTI, and so on. Each RNTI type is configured to a UE through higher layer signaling. A UE typically decodes at multiple candidate locations for PDCCH receptions as determined by an associated search space set.

With reference to FIG. 7, an example encoding process for a DCI format according to this disclosure is shown.

With reference to FIG. 8, an example decoding process for a DCI format for use with a UE according to this disclosure is shown.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in TS 38.212 [REF1]v17.6.0, or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ) mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in TS 38.213 [REF3]v17.6.0.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in TS 38.212 [REF1]v17.6.0, so that the DCI size limit would not be exceeded.

For each scheduled cell, the UE is not required to monitor on the active DL BWP with SCS configuration μ of the scheduling cell more than min(M_{PDCCH}^{max,slot,μ}, M_{PDCCH}^{total,slot,μ}) PDCCH candidates or more than min(C_{PDCCH}^{max,slot,μ}, C_{PDCCH}^{total,slot,μ}) non-overlapped CCEs per slot wherein M_{PDCCH}^{max,slot,μ}, and C_{PDCCH}^{max,slot,μ}, are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in TS 38.213 [REF3]v17.6.0.

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the limits/maximum per slot for scheduling on the primary cell mentioned herein, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in TS 38.213 [REF3]v17.6.0.

For same cell scheduling or for cross-carrier scheduling where a scheduling cell and scheduled cells have DL BWPs with same SCS configuration y, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in TS 38.213 [REF3]v17.6.0 and TS 38.214 [REF4]v17.6.0.

MIMO technologies have a key role in boosting system throughput both in NR and LTE and such a role will continue and further expand in the future generations of wireless technologies. For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

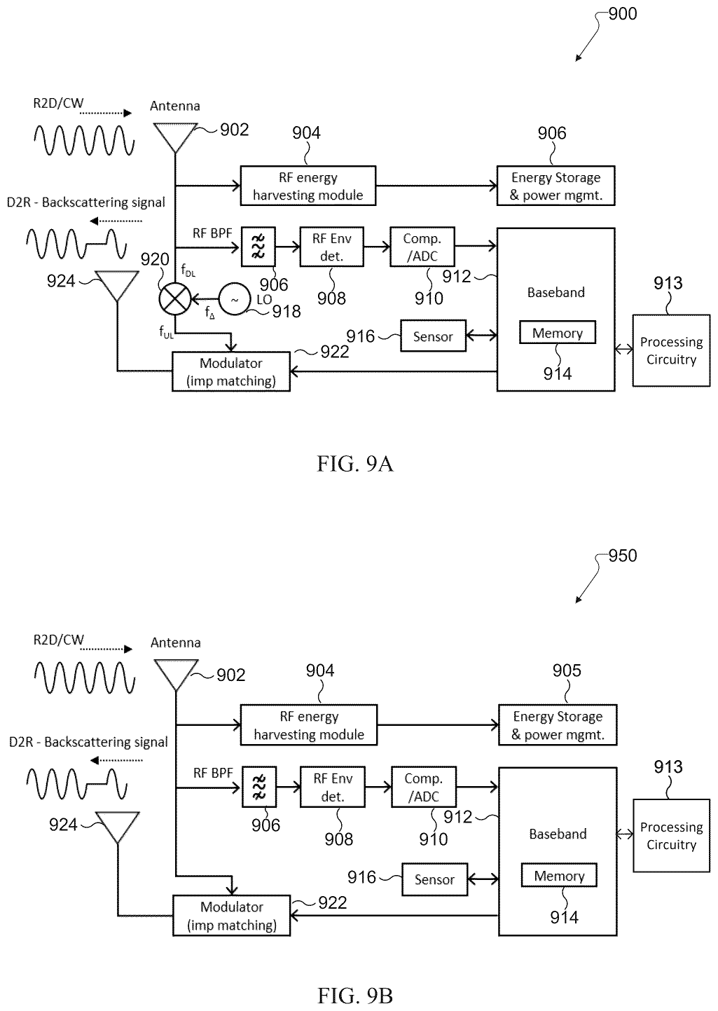

FIGS. 9A and 9B illustrate diagrams of example type-1 backscatter structures for IoT devices 900 and 950 according to embodiments of the present disclosure. For example, the IoT devices 900 and 950 can be implemented by a UE, such as UE 116 of FIG. 3, or may be devices with fewer components and functionality that a UE. This example is for illustration only and other embodiments can be used without departing from the scope of the present disclosure.

As shown in FIG. 9A, the type-1 backscatter structure for IoT device 900 includes an antenna 902, a RF energy harvesting module 904, an energy storage and power management 905, a RF bandpass filter (BPF) 906, a RF envelope detector 908, a comparator/analog to digital converter (ADC) 910, a baseband 912, processing circuitry 913, a memory 914, a sensor 916, a local oscillator (LO) 918, a mixer 920, a modulator (impedance matching) 922, and an antenna 924.

As shown in FIG. 9B, the type-1 backscatter structure for IoT device 950 includes an antenna 902, a RF energy harvesting module 904, an energy storage and power management 905, a RF BPF 906, a RF envelope detector 908, a comparator/ADC 910, a baseband 912, processing circuitry 913, a memory 914, a sensor 916, a modulator (impedance matching) 922, and an antenna 924.

Several different types of A-IoT devices are provided. One device type has ˜1 μW peak power consumption, energy storage, initial sampling frequency offset (SFO) up to 10^{X} ppm, neither DL nor UL amplification in the device, wherein the device's D2R transmission is backscattered on a carrier wave (CW) provided externally. This type of device is referred to as Type-1 backscatter device, or Type-1 device in short, in this disclosure. Another type of device has ≤ a few hundred μW peak power consumption, energy storage, initial sampling frequency offset (SFO) up to 10^{X} ppm, both DL and/or UL amplification in the device, wherein the device's D2R transmission may be generated internally by the device, or be backscattered on a CW provided externally, which are referred to as Type-2 active device and Type-2 backscatter device, respectively.

With reference to FIG. 9, example Type-1 backscatter device structures are shown.

The RF energy harvesting via RF energy harvesting module 904 can be a viable solution for supplying power to a Type-1 backscatter device requiring ˜1 μW peak power consumption. Either a R2D signal or an externally provisioned CW signal for backscattering can be utilized for RF energy harvesting. The CW is externally provided from a reader or a dedicated source. The source of CW signal, e.g., either a reader or a dedicated node, shall be agnostic to A-IoT devices. The harvested energy, e.g., using a rectifier, can be stored using a capacitor, super-capacitor, or, generally speaking, an energy storage of an energy storage and power management (component) 905.

The R2D signal is demodulated using a low complexity RF envelop detector 908 and comparator, whose output is provided as an input to the baseband 912. Given the low-power and low-complexity requirements of the Type-1 backscatter device, RF envelop detection is a viable solution for a receiver architecture, compared to a heterodyne architecture with IF envelope detection or a homodyne architecture with baseband envelope detection, which require LO and frequency mixer for frequency down-conversion. The input RF signal passes through an RF BPF 906, in the case of one or more implementations described herein, for an adjacent channel interference suppression, and then the filtered RF signal is directly converted into a digital signal using RF envelop detector 908 and an comparator/ADC 910, which can include an n-bit comparator, depending on the modulation scheme.

For the D2R backscatter transmission, the following cases are provided:
Case 1) CW is provisioned at DL spectrum and backscattered, i.e., CW @DL spectrum, D2R backscattering @DL spectrum.
Case 2) CW is provisioned at UL spectrum and backscattered, i.e., CW @UL spectrum, D2R backscattering @UL spectrum.
Case 3) CW is provisioned at DL spectrum, frequency shifted to UL spectrum, and then backscattered, i.e., CW @DL spectrum, D2R backscattering @UL spectrum.

The time division duplexing (TDD) spectrum case can be evaluated similarly as one of the Case 1) or Case 2), i.e., CW and D2R backscattering on the same frequency. The Case 3) for frequency division duplexing (FDD) spectrum requires a frequency shifter due to a duplex spacing which requires LO and frequency mixer. The duplex spacing of FDD spectrum ranges from at least 10 MHz to a few hundred MHz depending on the carrier frequency.

One or more implementations described herein expects Case 3), i.e., the D2R signal transmission is via backscattering of the externally provided CW involving a frequency shifter, if the CW is provided in a frequency different than the UL carrier frequency. Type-1 backscatter can also operate in a TDD spectrum. In this case, the device does not require a frequency shifter to obtain a desired frequency shifting. Taking into account that the A-IoT devices are targeting for low complexity and low power consumption, the following embodiments are provided as an example methods for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the UL carrier frequency; In this case, no frequency shifter is needed.
Use of harmonic frequencies of CW signal or intermodulation frequencies of two-tone CW signals.

One or more implementations described herein expects either Case 1) or Case 2), which does not require a frequency shifter.

One or more implementations described herein further include other implementation variations such as separate Tx-Rx antennas vs common Tx-Rx antenna, use of a sensor, etc. The implementations should be understood as an example and not as a restriction.

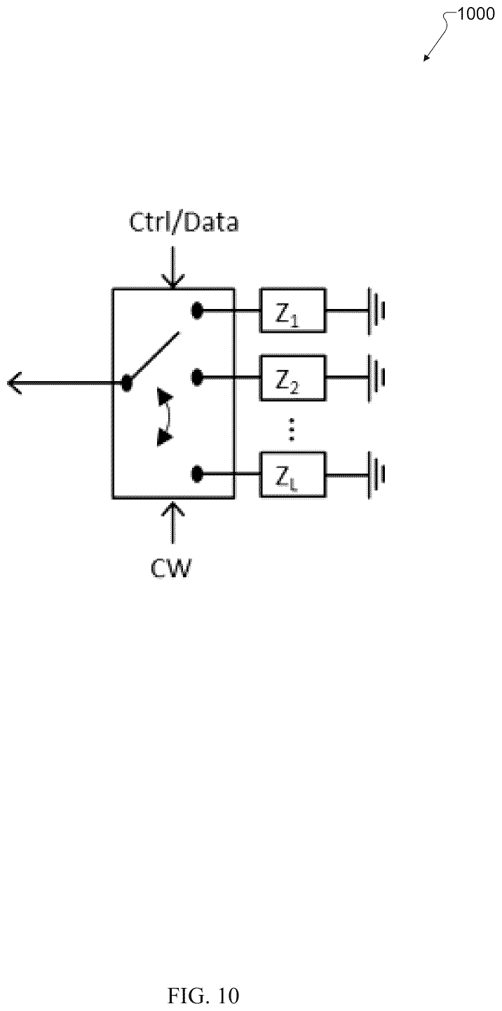

FIG. 10 illustrates a diagram of an example impedance matching circuit 1000 according to embodiments of the present disclosure. For example, impedance matching circuit 1000 can be implemented in the modulator (impedance matching) 922 of an IoT device. This example is for illustration only and other embodiments can be used without departing from the scope of the present disclosure.

With reference to FIG. 10, an example impedance matching circuit 1000 for backscatter device D2R modulation is shown.

The followings are simple examples of impedance matching operations:
Open circuit: Full reflection of the received CW signal in the same phase. This can be used for OOK modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log₂(L) bits per symbol amplitude shift keying (ASK) modulation.

Depending on the matched load impedance, the matching circuit 1000 can backscatter the incoming CW signal with different reflection coefficients in both amplitude and phase. In general, ASK/phase shift keying (PSK)/frequency shift keying (FSK) may be supported using an impedance matching circuit. As a simplest modulation scheme, OOK may be utilized for A-IoT, given its low complexity. The UE may indicate its modulation capability or impedance matching capability to the network (e.g., the network 130), or certain requirement may be predefined in the specification of system operation.

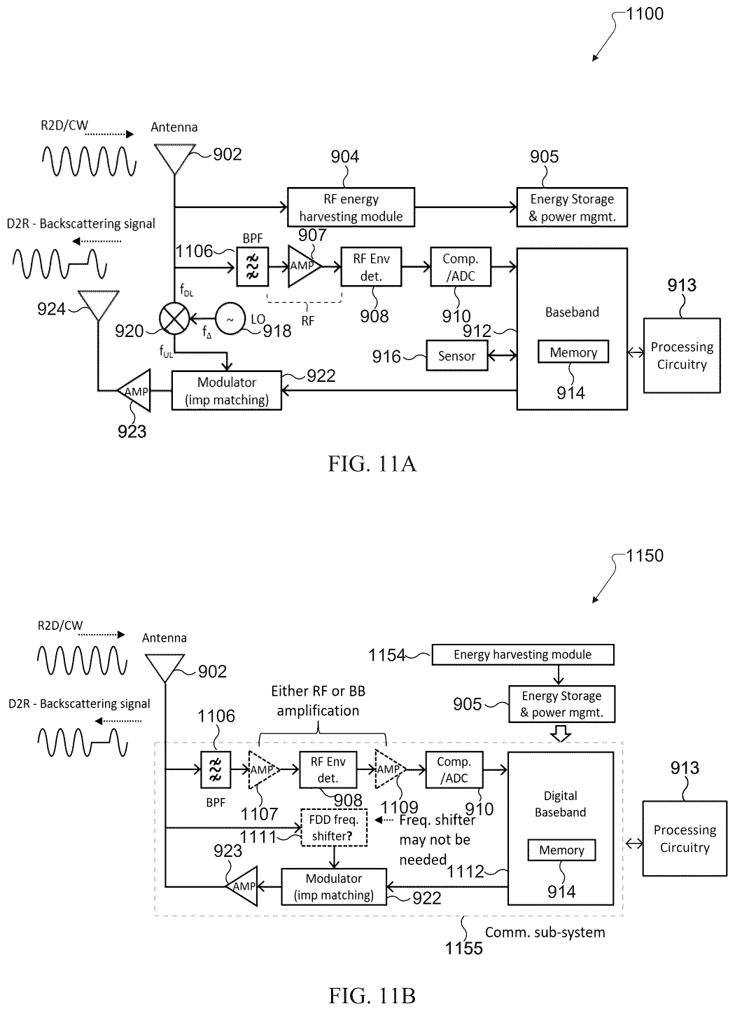

FIGS. 11A and 11B illustrate examples of type-2 backscatter structures for IoT devices 1100 and 1150 according to embodiments of the present disclosure. For example, IoT 1100 and 1150 can be implemented by a UE, such as UE 116 of FIG. 3, or may be devices with fewer components and functionality than a UE. This example is for illustration only and other embodiments can be used without departing from the scope of the present disclosure.

As shown in FIG. 11A, type-2 backscatter structure IoT device 1100 includes an antenna 902, an energy harvesting module 904, an energy storage and power management (component) 905, a bandpass filter 1106, amplifier 907, a RF envelope detector 908, a comparator/ADC 910, a baseband 912, processing circuitry 913, a memory 914, a sensor 916, a LO 918, a mixer 920, a modulator (impedance matching) 922, amplifier 923, and an antenna 924.

As shown in FIG. 11B, type-2 backscatter structure 1150 includes an antenna 902, an energy harvesting module 1154, an energy storage and power management (component) 905, and a communication sub-system 1155. The communication sub-system 1155 includes a bandpass filter 1106, amplifier 1107, a RF envelope detector 908, amplifier 1109, a comparator/ADC 910, a digital baseband 1112, processing circuitry 913, a memory 914, a modulator (impedance matching) 922, an amplifier 923, and a (optional) FDD frequency shifter 1111.

With reference to FIG. 11, example Type-2 backscatter device structures are shown.

The Type-2 backscatter device may share similar structure at large with the Type-1 device as the D2R transmission is still based on backscattering of an externally provided CW, while the Type-2 backscatter device may differ from Type-1 device from the following aspects.

The Type-2 device has ≤ a few hundred μW peak power consumption and both DL and/or UL amplification in the device. In this case, alternative to the RF energy harvesting from a R2D signal (e.g., a PRDCH) or an externally provided CW signal as illustrated in one or more implementations described herein, other renewable energy sources, e.g., solar, thermal, kinetic, etc., may be evaluated for energy harvesting, as illustrated in one or more implementations described herein. The presence of a certain energy harvesting capability from a certain renewable energy source may be expected for system design point of view.

The Type-2 devices may be equipped with both DL and/or UL amplification in the device. Given the power consumption requirement, i.e., ≤ a few hundred μW, the DL/UL amplification for Type-2 devices may be based on an architecture that is different from the common power amplifier (PA) and low noise amplifier (LNA) based on metal-oxide-semiconductor field-effect transistor (MOSFET). In some example low-power/complexity forward amplification (for R2D reception) and reflection amplification (for D2R backscattering) architectures, a single bipolar transistor terminated with microstrips may be used. The DL amplification can be either RF amplification by amplifier 907 prior to the envelop detector 908, as illustrated in one or more implementations described herein, or baseband amplification by amplifier 1109 prior to the comparator/ADC 910 as illustrated in one or more implementations described herein, which is an implementational choice.

One additional difference of Type-2 devices compared to Type-1 devices may be a use of FDD frequency shifter. With a few hundred μW peak power consumption, some low-power LO architectures with a frequency mixer can be envisioned for Case 3).

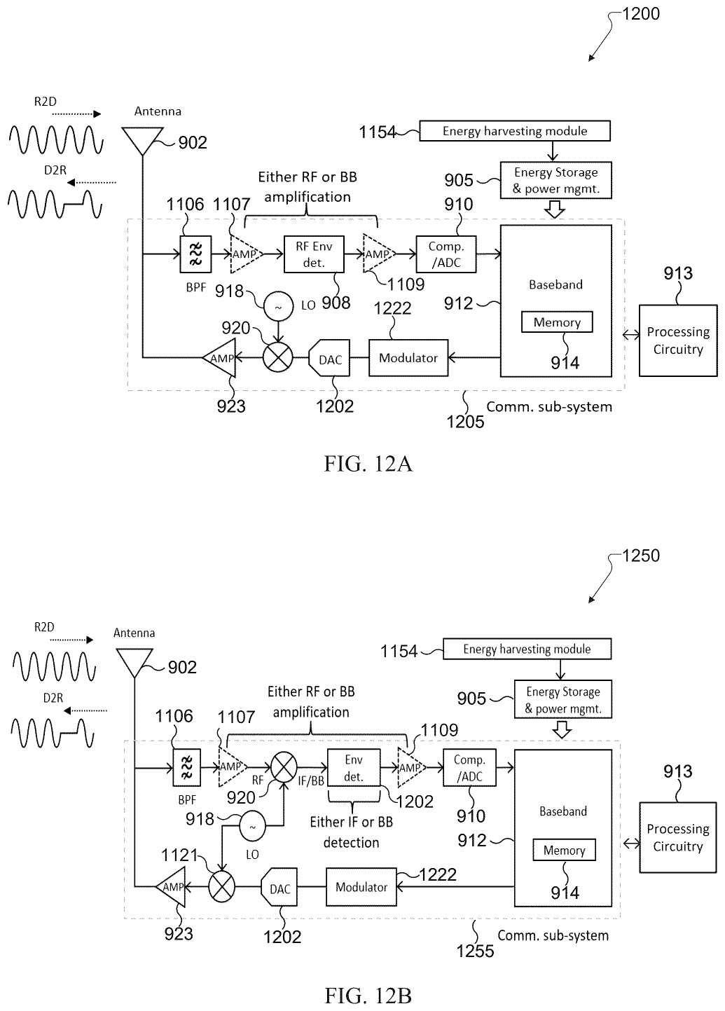

FIGS. 12A and 12B illustrate examples of type-2 active structures for IoT devices 1200 and 1250 according to embodiments of the present disclosure. For example, IoT devices 1200 and 1250 can be implemented by a UE, such as UE 116 of FIG. 3, or may be devices with fewer components and functionality than a UE. This example is for illustration only and other embodiments can be used without departing from the scope of the present disclosure.

As shown in FIG. 12A, the type-2 active structure of IoT device 1200 includes an antenna 902, an energy harvesting module 1154, an energy storage and power management (component) 905, and a communication sub-system 1205. The communication sub-system 1205 includes a bandpass filter 1106, an amplifier 1107, a RF envelop detector 908, an amplifier 1109, a comparator/ADC 910, a baseband 912, processing circuitry 913, a memory 914, a modulator 1222, a digital to analog converter (DAC) 1202, a LO 918, a mixer 920, and an amplifier 923.

As shown in FIG. 12B, the type-2 active structure of IoT device 1250 includes an antenna 902, an energy harvesting module 1154, an energy storage and power management (component) 905, and a communication sub-system 1255. The communication sub-system includes a bandpass filter 1106, amplifier 1107, a mixer 920, an envelope detector 1202, an amplifier 1109, a comparator/ADC 910, a baseband 912, processing circuitry 913, a memory 914, a modulator 1222, a DAC 1202, a LO 918, a mixer 1121, and an amplifier 923.

With reference to FIG. 12, example Type-2 active device structures are shown.

The Type-2 active device shares similar structure at large with the Type-2 passive device other than the D2R signal is internally generated using LO rather than backscattering the externally provided CW. The example architecture shown in FIG. 12 is based on a common active transmitter chain, wherein the D2R data is modulated, converted to an analog signal using digital to analog converter (DAC) and, then up-converted to a UL carrier frequency using LO and frequency mixer, which is followed by an amplifier.

In one or more implementations described herein, the R2D receiver chain is still based on the RF envelop detector 908 as in the previous architectures. In one or more implementations described herein, the R2D receiver chain is based on IF or BB envelop detection. In the heterodyne architecture, the RF signal is down converted into an intermediate frequency and then detected using envelope detector 908. In the homodyne/zero-IF architecture, the RF signal is directly down converted into baseband signal and then detected using envelope detector 1202.

FIGS. 9-12 should be understood for illustration purpose only. There can be other components not explicitly shown in the figure such as switch, duplexer, and filters, or some components may be replaced to different options. Also, the devices can operate both in TDD and FDD spectrum and, depending on the operating spectrum, the actual architectures can be different from the conceptual illustrations in the figures.

In deploying A-IoT devices, different topology options can be evaluated. The following provides examples of topology options:
Topology 1: BS↔A-IoT device
   An A-IoT device directly and bidirectionally communicates with a base station. The communication between the base station and the A-IoT device includes A-IoT data and/or signalling. This topology includes that the BS transmitting to the A-IoT device is different from the BS receiving from the A-IoT device.
Topology 2: BS↔intermediate node↔Ambient IoT device
   An A-IoT device communicates bidirectionally with an intermediate node between the device and base station. In this topology, the intermediate node can be a relay, IAB node, UE, repeater, etc. which is capable of A-IoT. The intermediate node transfers A-IoT data and/or signalling between BS (e.g., the BS 102) and the A-IoT device. The intermediate node is referred to as I-node in this disclosure.
Topology 3: BS↔assisting node↔Ambient IoT device↔BS
   An A-IoT device transmits data/signalling to a base station, and receives data/signalling from the assisting node; or the A-IoT device receives data/signalling from a base station and transmits data/signalling to the assisting node. In this topology, the assisting node can be a relay, IAB, UE, repeater, etc. which is capable of A-IoT.
Topology 4: UE↔Ambient IoT device
   An A-IoT device communicates bidirectionally with a UE. The communication between UE and the A-IoT device includes A-IoT data and/or signalling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be expected that the deployment of A-IoT can be on new sites without an assumption of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

Any operations performed by BS in this disclosure can be also performed by I-node instead of the BS, and each or part of interfaces are transparent to the A-IoT devices.

For precise synchronization, the SFO requirement to NR is within ±0.1 parts per million (PPM). In comparison, taking RFID as a reference, SFO for A-IoT may be ±10-20 PPM. Given the low complexity and the low power consumption requirements for A-IoT devices, it is apparent that the oscillators equipped with A-IoT devices will be significantly subpar to that equipped with a normal NR UE. It is therefore impractical to expect a precise timing capability for A-IoT devices as it is usually expected for normal NR UEs. Furthermore, given that A-IoT devices are powered by harvesting energy, the device may be running out of power time to time and, thereby, loosing timing, i.e., lacking timing maintaining capability.

As one main use case of A-IoT is inventory, e.g., asset identification and tracking. Embodiments of the present disclosure recognize that there is a need to define procedures and methods for identifying A-IoT devices.

The device identification triggering message may be a blind inquiry and, therefore, a device previously identified may attempt the random access again.

Therefore, embodiments of the present disclosure further recognize that there is a need to define procedures and methods for selectively restricting the previously identified UEs accessing the random transmission opportunities again.

When there are a large number of devices in a proximity, there can be an excessive random access attempts resulting in a high collision probability.

Therefore, there is a need to define procedures and methods for limiting the set of devices attempting the random access for given random access occasions.

Once an A-IoT device is identified, the network may command the identified A-IoT device to perform a certain operation.

In order to support device-originated autonomous (DO-A) traffic types or to allow UE initiated D2R transmissions, there is a need to define procedures and methods for UE autonomous D2R transmission mode.

In any of the transmission modes, given different types of devices with and without D2R amplification, there is a need to define procedures and methods for D2R power control.

Taking into account the low accuracy clock equipped with an A-IoT devices, the D2R transmission timing can be drifted, which may create interference for D2R multi-access.

Therefore, there is another need to define procedures and methods for D2R transmission timing correction.

Lastly, for various communication modes, there is a need to define procedures and methods to efficiently address a subset of devices for groupcast.

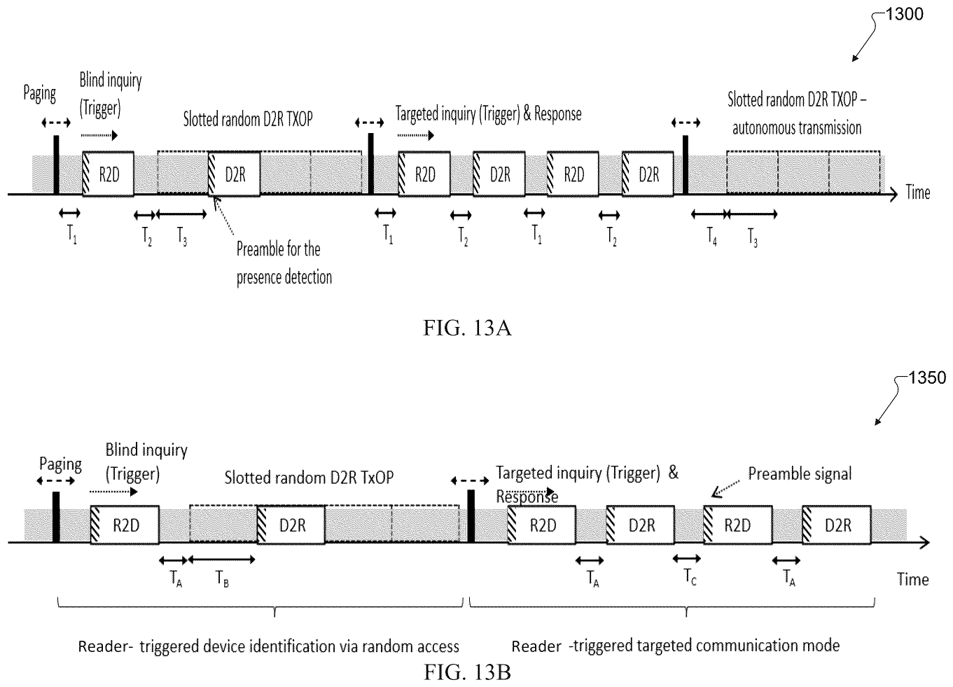

FIGS. 13A and 13B illustrates timelines 1300 and 1350 for example reader-guided asynchronous systems and different communication modes according to embodiments of the present disclosure. For example, timelines 1300 and 1350 can be followed by the IoT devices described herein. This example is for illustration only and other embodiments can be used without departing from the scope of the present disclosure.

With reference to FIG. 13, an example of reader-guided asynchronous system and different communication modes according to the disclosure.

In the figure, it is illustrated such that R2D/D2R signals are prepended with a sequence for the presence detection, i.e., preamble.

In a reader-guided asynchronous system, the reader provides a basis for determining a relative timing and an A-IoT device doesn't need to maintain an absolute timing as one transmission follows another. In a reader-guided asynchronous system, one or more R2D/D2R transmissions are triggered and led by a transmission from a reader.

With reference to FIG. 13A, the paging signal serves as a timing basis and an initial R2D transmission follows the preceding paging signal with time interval T₁. With reference to FIG. 13B, the paging signal does not serve as a timing basis and a R2D transmission can start any time, not related to the paging timing.

With reference to FIG. 13, the paging signal, which is also referred to as a beacon or as an A-IoT SSB (A-SSB) signal, serves as a leading signal to which other signals follow. In order to prioritize different signals/channels or traffic types, e.g., DT, DO-DTT, and DO-A, or different QoS type traffics, e.g., video, voice, best effort, and background, one or multiple relative timing parameters can be defined as shown in the figure. In FIG. 13A, a R2D transmission can follow a preceding paging signal in T₁ time, while an autonomous transmission can start after T₄ time has elapsed. By assigning different amount of relative timing parameters to different transmissions, priorities between different transmissions can be applied. In one example, T₁ can be set to be shorter than T₄ such that R2D transmission from a reader has higher priority than D2R autonomous transmission. In the figure, a D2R transmission in response to a preceding R2D transmission can start in T₂ time, and during the T₂ time no other transmissions can start and, thereby, providing highest priority to D2R response following R2D transmission.

In FIG. 13B, a D2R transmission may follow the preceding R2D transmission as early as in T_{A}. There may be multiple different T_{A} parameters, i.e., T_{A}′, T_{A}″, . . . , to schedule a delayed D2R transmission for multiplexing transmissions from different A-IoT devices. The slot duration for random access transmission opportunities (TxOPs) is denoted by T_{B}. A R2D transmission may follow the preceding D2R transmission in T_{C}.

An A-IoT device may receive D2R scheduling information from the serving reader including the timing parameter for D2R transmission. The D2R transmission timing may be referenced to the preceding R2D reception time. There may be multiple different sets of timing parameters. The timing parameters may be in ms, an integer multiple of certain time unit, such as basic time unit, symbol duration, or chip duration. The timing, in its absolute value or as an index from a set of predefined values, may be indicated to the UE in the preceding R2D transmission.

In another embodiment, a part or each of the relative timing parameters herein such as T₁, T₂, T₃, and T₄, or T_{A}, T_{B}, T_{C} are provided in a paging as a part of system information or predefined in the specifications of the system operation.

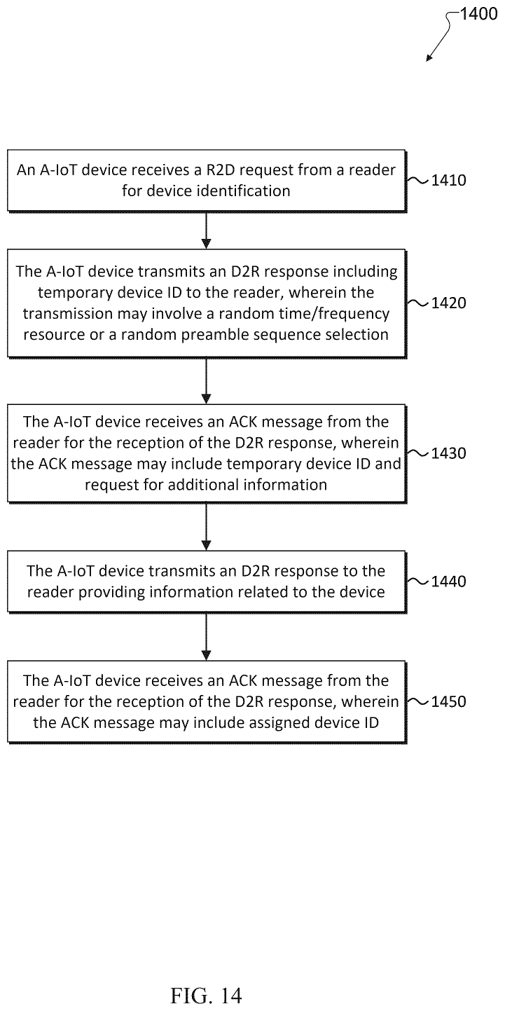

FIG. 14 illustrates a flowchart of an example procedure 1400 for reader-triggered device identification according to embodiments of the present disclosure. For example, procedure 1400 for reader-triggered device identification can be performed by the IoT devices described herein. This example is for illustration only and other embodiments can be used without departing from the scope of the present disclosure.

The procedure begins in 1410, an A-IoT device receives a reader-to-device (R2D) request from a reader for device identification. In 1420, the A-IoT device transmits a device-to-reader (D2R) response including temporary device ID to the reader, wherein the transmission may involve a random time/frequency resource or a random preamble sequence selection. In 1430, the A-IoT device receives an acknowledgement (ACK) message from the reader for the reception of the D2R response, wherein the ACK message may include temporary device ID and request for additional information. In 1440, the A-IoT device transmits a D2R response to the reader providing information related to the device. In 1450, the A-IoT device receives an ACK message from the reader for the reception of the D2R response, wherein the ACK message may include assigned device ID.

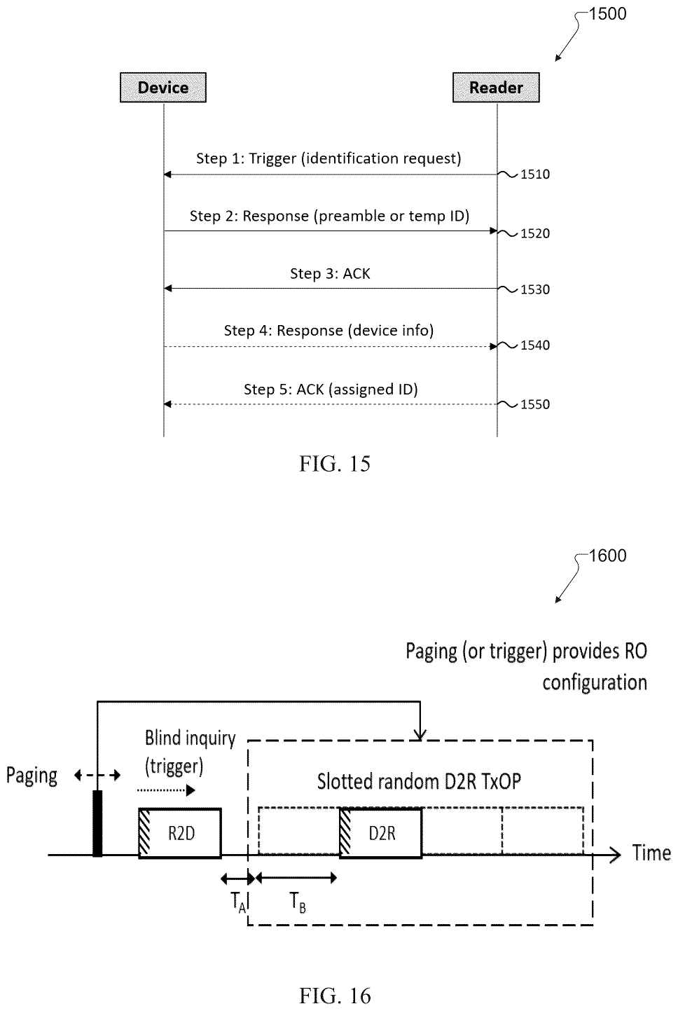

FIG. 15 illustrates a flowchart of an example procedure 1500 for reader-triggered device identification according to embodiments of the present disclosure. For example, procedure 1500 for reader-triggered device identification can be performed by an A-IoT device, such as IoT devices 900, 950, 1100, 1150, 1200, or 1250, and a reader, such as the BS 102. This example is for illustration only and other embodiments can be used without departing from the scope of the present disclosure.

The procedure begins in 1510, a reader transmits a trigger (identification request) to a device. In 1520, the device transmits a response (preamble or temp ID) to the reader. In 1530, the reader transmits an ACK to the device. In 1540, the device may transmit a response (device info) to the reader. In 1550, the reader may transmit an ACK (assigned ID) to the device.

In a D2R transmission, the A-IoT device may include its buffer status report and/or energy status report. Such a D2R transmission may be a random access D2R transmission in a device identification process, the first D2R transmission in a triggered/scheduled D2R transmission, or an indicated D2R transmission by the reader to provide such reports. The energy status report may include its current energy storage level as an absolute value or as an index to a set of predefined range values. As an example, it can be 1-bit indication indicating one from two predefined range values. In the case of Type-2 devices, the energy status report may indicate its ability/inability of D2R amplification, given the current energy level.

The paging message may provide various system information required by the A-IoT devices such as
parameters related to D2R power control including target D2R reception power, pathloss scaling factor, etc.
parameters related to D2R random access including random access transmission occasion configuration, e.g., number of slots for random access, slot duration etc., maximum number of allowed random access transmissions, initial random access target D2R reception power, response monitoring window after transmitting the random access, prohibit timer after a failed random access attempt, power ramping steps, allowance of D2R power amplification.
parameters related to D2R autonomous access, e.g., number of slots for autonomous access, slot duration, maximum payload size, etc.
parameters related to CW including one or more CW carrier frequencies, BW, waveform related information, numerologies, etc.
parameters related to channel BW, numerologies, etc.

The paging signal also severs as a wake-up signal. When a paging is received, an A-IoT device expects that an A-IoT communication session is activated and on-going. Therefore, the A-IoT device is expected to receive R2D signals. On the other hand, if an A-IoT device does not receive a paging signal for a certain time duration, the A-IoT device expects that the A-IoT communication session is inactive and the device is not required to receive R2D signals. The certain time duration may be a fixed or nominal paging interval, which may be provided in the paging message itself or predefined in the specifications of the system operations.

The general principle for reader-triggered device identification includes a R2D transmission from a reader initiating the device identification process and a random access transmission by an A-IoT device (e.g., the IoT device 950), which may involve a random time/frequency resource selection with or without random preamble selection.

With reference to FIG. 14, an example flowchart of a UE to perform reader-triggered device identification according to the disclosure is shown.

FIG. 15 illustrates a signal flow of reader-triggered device identification associated with the flowchart illustrated in FIG. 14 according to the disclosure.

FIG. 16 illustrates a timeline 1600 for reader-triggered device identification according to embodiments of the present disclosure. For example, timeline 1600 for reader-triggered device identification can be followed by the IoT devices described herein. This example is for illustration only and other embodiments can be used without departing from the scope of the present disclosure.

With reference to FIG. 16, an example of reader-triggered device identification according to the disclosure is shown. A R2D/D2R signal may be prepended with a sequence for the presence detection, e.g., preamble. Alternatively, in other scenario wherein a synchronized transmission is expected, a R2D/D2R signal may not be prepended with a sequence for the presence detection.

An A-IoT device receives a R2D request from a reader for device identification 1410. The R2D request message can be one type of R2D control signal transmitted by a reader, which may follow the preceding paging with T₁ time interval. In another example, as shown in FIG. 16, there is no such timing relationship between a R2D message and the preceding paging. The R2D request message for device identification may be a blind inquiry wherein the reader may have no prior knowledge on the presence of A-IoT devices in proximity. The inquiry message may be for the entire A-IoT devices in the proximity or a subset of A-IoT devices in the proximity. In the first example, the inquiry message may indicate NULL or physical cell ID (PCI) in the message destination field. In the second example, the inquiry message may indicate a device group ID in the message destination field.

Given that it is a blind inquiry, a device previously identified may attempt the random access again. Therefore, there is a need to restrict the previously identified devices accessing the random transmission opportunities. In one example, there is a timer such that a previously identified device does not participate the identification process again while the timer is running. The timer may be predefined or indicated to the device. In another example, the triggering message may indicate whether the identification is for an initial identification for the devices which have not been identified yet, for reidentification for the devices which have been already identified, or unrestricted, i.e., for both previously identified and unidentified devices. In yet another example, the triggering message may specifically indicate a particular device or a set of devices to perform reidentification. In this case, the triggering message includes one or more device IDs, or a device group ID.

The A-IoT device transmits a D2R response including temporary device ID to the reader, wherein the transmission may involve a random time/frequency resource or a random preamble sequence selection 1420.

In NR, the physical random access channel (PRACH) preamble is utilized for estimating D2R timing advancement (TA) for the UE. In the A-IoT communication, such TA estimation may not be necessary or meaningful due to the reasons such as 1) evaluations on the asynchronous system operation, 2) indoor scenario with a limited coverage, i.e., a few tens of meters, and 3) non-negligible clock drift. Nonetheless, the use of code domain resource selection, i.e., PRACH preamble selection, can be adopted in the system design to provide collision avoidance in addition to random time/frequency resource selection when many A-IoT devices respond at the same time.

If code domain resource selection is used, the chosen preamble sequence itself may serve as a temporary ID. Alternatively, when the code domain resource selection is not used, the response message can include a payload containing a temporary UE ID. The temporary UE ID may be a randomly generated number or associated with the unique ID of the device. The parameters related to D2R random access may be provided by the triggering message in Step 1 or by the pagings.

With reference to FIG. 16, the D2R response may be transmitted in one of the random transmission opportunities comprising of one or multiple transmission occasions. A set of parameters related to the random access occasion (RO) including the number of slots providing random transmission opportunities, duration of a slot T_{B}, and a starting offset T_{A}, may be provided in the paging or the preceding R2D request message. The A-IoT device may select a random preamble sequence in addition to the RO selection or alternative to the RO selection. A set of allowed preambles for selection, i.e., a pool, by A-IoT devices may be also provided in the paging or the preceding R2D request message.

The D2R response may include a fixed or random preamble signal and a payload data. Alternatively, the D2R signal may only comprise of a random preamble signal. When a fixed preamble is transmitted or a random preamble is transmitted with a payload data, a temporary UE ID may be provided in the payload. A temporary UE ID may be a random number selected by the A-IoT device, which can be drawn from [0, 2^{N}−1] or [1, 2^{N}] wherein parameters related to the random number selection such as N can be predefined in the specification of system operation or provided to the A-IoT device in the paging or R2D request signal. Alternatively, a temporary UE ID may be an ID associated with the device such as international mobile equipment identity (IMEI), embedded identity document (EID), international mobile subscriber identity (IMSI), s-temporary mobile subscriber identity (S-TMSI), or product code such as serial number or a unique ID assigned when the device is deployed. The temporary UE ID may be a shortened version of an ID associated with the device. When only a random preamble is transmitted, an index of the transmitted preamble sequence serves as the temporary UE ID.

When there are a large number of devices in a proximity, there can be an excessive random access attempts resulting in a high collision probability. As one method for controlling the collision probability, the gNB (e.g., the BS 102) may limit the set of devices attempting the random access for given random access occasions. In one example, the network (e.g., the network 130) may indicate the device group ID such that the devices having matching group ID only performs the random access. In another example, the devices satisfying certain conditions, e.g., modulo(UE ID, K)=0, only performs the random access. For instance, if K=2, the devices having it's ID divided by 2 with zero remainder can perform the random access. In this example, the UE ID, and K can be in any format, such as decimal, hexadecimal, etc. In yet another example, the serving gNB may provide a probability P to perform random access. That is, a device attempts random access by randomly generating a Bernoulli random variable with probability P and when the generated number is equal to 1. The random trial may be performed in a slot basis within a series of D2R transmission opportunities independently. In another example, the random trial is performed for the given series of D2R transmission opportunities. If the device decided to attempt a transmission, then it randomly selects one slot from the series of D2R transmission opportunities. The related parameters for the access control methods herein, such as UE group ID, modulo parameter K, or the probability parameter P, can be indicated to the devices.

If a device does not perform random access for the given series of D2R transmission opportunities, the device waits until the next series of D2R transmission opportunities.

The A-IoT device receives an ACK message from the reader for the reception of the D2R response, wherein the ACK message may include temporary device ID and request for additional information 1430. When there is a low probability of collision of temporary device ID among multiple A-IoT devices, the temporary device ID is promoted to an assigned device ID and the process terminates at this step. When an ID associate with the device or a random number from a sufficiently long range is used, the probability of collision of temporary device ID may be reliably expected to be low. When there is a chance of collision of temporary device ID, e.g., a random preamble index serves as temporary device ID from a limited set of sequences or a random number is drawn from a limited range whose probability of collision cannot be expected low, the subsequent steps are performed for contention resolution.

The device may await for the ACK message for a certain time duration, which may be indicated to the UE or predefined by the specifications of the system operation. If indicated, it may be provided in the random access triggering message or in a paging message as a part of system information. If a device does not receive ACK message for the certain time duration, the device may perform the random access attempts again. In doing this, there may be a prohibit timer, indicated or predefined, that the device refrains attempting the random access while the timer is running.

The A-IoT device transmits a D2R response to the reader providing information related to the device 1440. The information related to the device can be an ID associated with the device such as IMSI, S-TMSI, or product code, if it is not used as a temporary UE ID in 1420. The A-IoT device receives an ACK message from the BS for the reception of the D2R response, wherein the ACK message may include assigned UE ID 1450. The assigned UE ID serves similar purpose as C-RNTI in NR system and it can be used for subsequent communication.

In transmitting the D2R random access message, the A-IoT device may perform D2R power control. The R2D pathloss for D2R power control may be measured from the preceding R2D triggering message, e.g., the preamble of the R2D signal, or from the preceding paging message. The D2R transmission power is a function of a target reception power at the gNB and the measured R2D pathloss. The target reception power can be provided in the preceding R2D triggering message or the paging message. In the case of Type-1 device, the power control is only performed in a reduction of the transmission power by adjusting the reflection coefficient. In the case of Type-2 backscatter device, the power control may be performed in a reduction of the transmission power by adjusting the reflection coefficient or in an increase of the transmission power by adjusting the amount of D2R amplification, within the maximum amplification capability. In the case of Type-2 active device, the power control may be performed in the same manner as the normal NR UEs, wherein the power control is also a function of PCMAX.

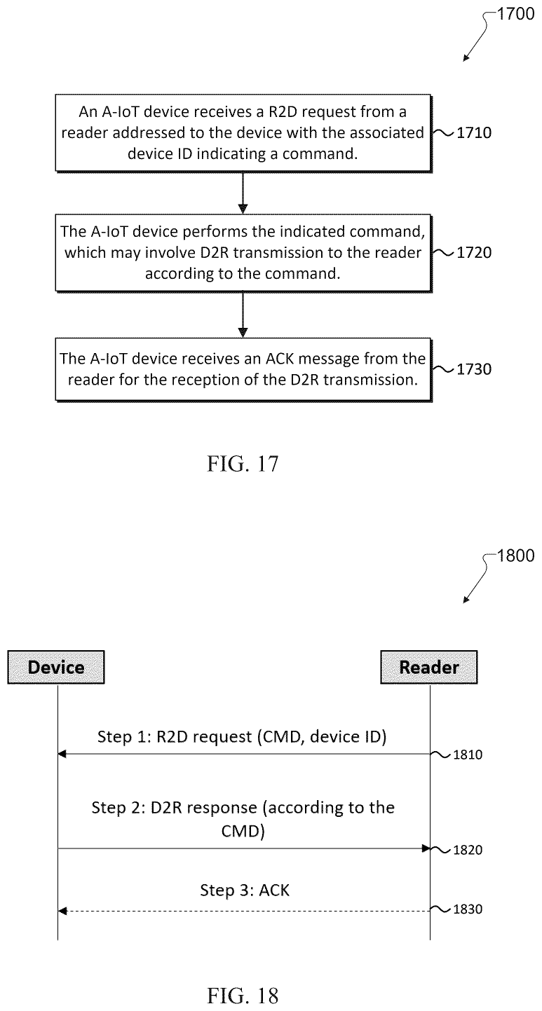

FIG. 17 illustrates a flowchart of an example procedure 1700 for reader-triggered communication according to embodiments of the present disclosure. For example, procedure 1700 for reader-triggered communication can be performed by any of the IoT devices described herein. This example is for illustration only and other embodiments can be used without departing from the scope of the present disclosure.

The procedure begins in 1710, an A-IoT device receives a R2D request from a reader addressed to the device with the associated device ID indicating a command. In 1720, the A-IoT device performs the indicated command, which may involve D2R transmission to the reader according to the command. In 1730, the A-IoT device receives an ACK message from the reader for the reception of the D2R transmission.

FIG. 18 illustrates a flowchart 1800 for reader-triggered communication according to embodiments of the present disclosure. For example, flowchart 1800 for reader-triggered communication can be performed by an A-IoT device, such as IoT devices 900, 950, 1100, 1150, 1200, or 1250, and a reader, such as the BS 103. This example is for illustration only and other embodiments can be used without departing from the scope of the present disclosure.

The procedure begins in 1810, a reader transmits a R2D request (CMD, device ID) to a device. In 1820, the device transmits a D2R response (according to the CMD). In 1830, the reader may transmit an ACK to the device.

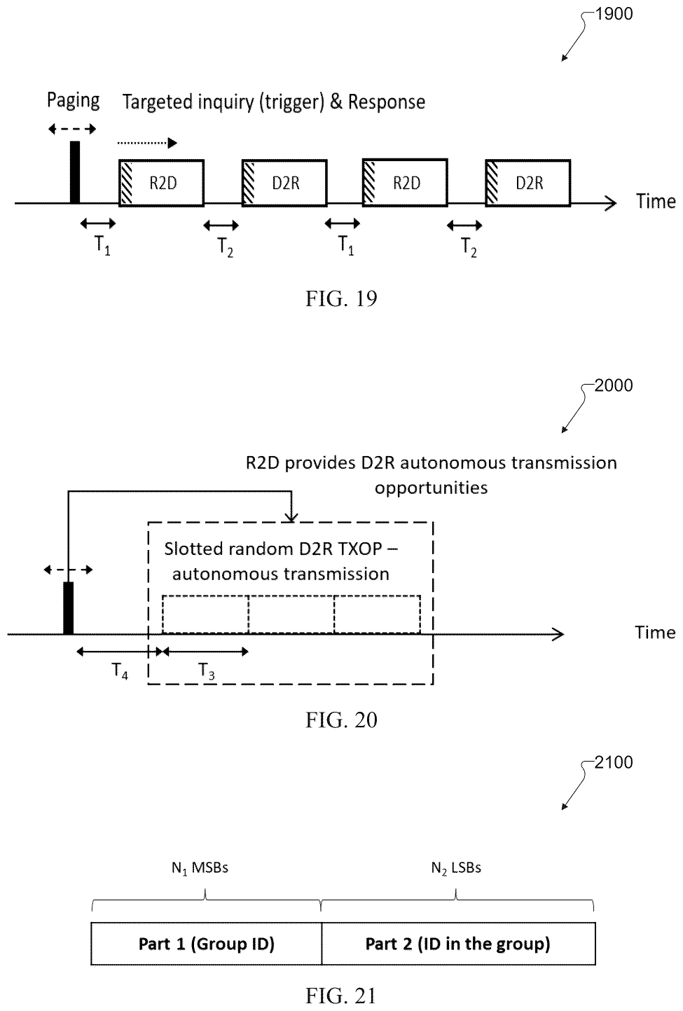

FIG. 19 illustrates a timeline 1900 for reader-triggered communication according to embodiments of the present disclosure. For example, timeline 1900 for reader-triggered communication can be followed by any of the IoT devices described herein. This example is for illustration only and other embodiments can be used without departing from the scope of the present disclosure.

The general principle for reader-triggered targeted communication includes a R2D transmission indicating a certain command addressed to a targeted A-IoT device using an associated device ID which have been previously identified, and the targeted A-IoT device performs the indicated command in the R2D transmission, which may involve D2R transmission to the reader.

With reference to FIG. 17, an example flowchart of a UE to perform reader-triggered targeted communication according to the disclosure is shown.

FIG. 18 illustrates a signal flow of reader-triggered targeted communication associated with the flowchart illustrated in FIG. 17 according to the disclosure.

With reference to FIG. 19, an example of reader-triggered targeted communication according to the disclosure. A R2D/D2R signal may be prepended with a sequence for the presence detection, e.g., preamble. Alternatively, in other scenario wherein a synchronized transmission is expected, a R2D/D2R signal may not be prepended with a sequence for the presence detection.

In one example, the initial targeted inquiry message follows the preceding paging message with a certain time interval T₁. In another example, there is no such timing relationship between the initial targeted inquiry message and the preceding paging message as illustrated in FIG. 13.

An A-IoT device receives a R2D request from a reader addressed to the device with the associated device ID indicating a command 1710. The associated device ID can be an ID associated with the device such as IMEI, EID, IMSI, S-TMSI, or product code such as serial number or a unique ID assigned when the device is deployed. Alternatively, the associated device ID can be an ID assigned by the reader during a previous device identification process. The R2D request for targeted communication includes a command to the A-IoT device. Examples of commands include device reidentification, R2D data transmission, D2R data request, buffer or battery status report, etc. When it is for R2D data transmission, the R2D request message may include a payload providing R2D data to the targeted device. Alternatively, the R2D request message itself does not include R2D data and the R2D data transmission may follow the R2D request message, e.g., in T₁ time, in a separate R2D signal transmission to the targeted device.

The R2D triggering message may provide parameters related to the D2R transmission. In one example, D2R power control related parameters are provided. In another example, D2R scheduling information is included, such as the timing of the D2R transmission following the R2D reception in terms of a time delay from the R2D reception timing. The time delay may be indicated in a unit of ms, chip, symbol, or slot, etc., or as an index from a set of predefined values. In another example, the D2R scheduling information includes the modulation order, such as the number of chips in a given symbol duration, and the D2R transmission duration in number of symbols, slots, a time span, or a payload size, inclusion of error detection/correction codes.

The A-IoT device performs the indicated command, which may involve D2R transmission to the reader according to the command 1720. The D2R transmission can be an ACK feedback for the reception of the R2D data transmission. The D2R transmission can be a D2R data transmission, buffer or battery status report according to the command received in the R2D request message. The D2R transmission may follow the preceding R2D request message in T₂ time.

The A-IoT device receives an ACK message from the reader for the reception of the D2R transmission 1730. If the D2R transmission by the A-IoT device is an ACK feedback for the reception of the R2D data transmission, this step may be omitted. Otherwise, if the D2R transmission includes a D2R data or certain reporting, the reader may transmit an ACK feedback to the targeted device. In case if step 1720 is unsuccessful, i.e., no D2R transmission is received by the reader, it may be because the previously identified device is missing, e.g., out of coverage, no energy for D2R transmission, or faulty. In such a case, the reader may perform reader-triggered device identification process.

In transmitting the D2R random access message, the A-IoT device may perform D2R power control. The initial D2R power control can be based on the R2D pathloss measured from the preceding R2D triggering message, e.g., the preamble of the R2D signal, or from the preceding paging message as in the case of random access transmission disclosed herein. The parameters related to the D2R power control, such as target received power, the fractional power control factor α, can be provided to the A-IoT devices in the preceding R2D triggering message or in the paging.

After the initial transmission, the A-IoT device may receive D2R power control adjustment indication, Δ, in a subsequent R2D control message, which applies to the current D2R transmission power. For the power control message, the R2D message indicates the amount of power reduction or increase, which may be provided as a dB value, or as an index to the set of values predefined in the specifications of the system operation. In the case of Type-1 device, the power control is only performed in a reduction of the transmission power with respect to the full reflection by adjusting the reflection coefficient. In the case of Type-2 backscatter device, the power control may be performed in a reduction of the transmission power with respect to the full reflection by adjusting the reflection coefficient or in an increase of the transmission power by adding additional power via D2R amplification, within the maximum amplification capability. In the case of Type-2 active device, the power control may be performed in the same manner as the normal NR UEs, wherein the power control is also a function of PCMAX.

FIG. 20 illustrates a timeline 2000 for reader-triggered D2R autonomous transmission according to embodiments of the present disclosure. For example, timeline 2000 for reader-triggered D2R autonomous transmission can be followed by an A-IoT device, such as IoT devices 900, 950, 1100, 1150, 1200, or 1250. This example is for illustration only and other embodiments can be used without departing from the scope of the present disclosure.

The general principle for reader-triggered D2R autonomous transmission includes a reader (e.g., the BS 102) transmitting a R2D triggering signal and the A-IoT devices performing random access for D2R transmission.

With reference to FIG. 20, an example reader-triggered D2R autonomous transmission according to the disclosure is shown. A D2R autonomous transmission may be prepended with a sequence for the presence detection, e.g., preamble. Alternatively, in other scenario wherein a synchronized transmission is expected, the D2R autonomous transmission may not be prepended with a sequence for the presence detection.

With reference to FIG. 20, the R2D triggering signal can indicate that there are random D2R transmission opportunities following the signal. Alternatively, there can be a R2D signal following the R2D triggering signal indicating that there are random D2R transmission opportunities following the R2D signal. Alternatively, if no other transmission is received within a certain time duration, e.g., T₄, following the R2D triggering signal, a device may initiate an autonomous D2R transmission. Random D2R transmission opportunities can be configured by the R2D triggering signal which may provide parameters related to the D2R transmission opportunities such as number of slots, slot durations, etc. The D2R autonomous transmission is performed by selecting a time slot from a number of slots randomly. After performing D2R autonomous transmission, the A-IoT device waits for an ACK message from the reader for a certain time duration, and if no ACK message is received, it can be interpreted that the D2R autonomous transmission was unsuccessful. In such a case, the A-IoT device may perform backoff such as by prohibiting another D2R autonomous transmission for a certain time duration, e.g., using a prohibit timer.

In another example, the A-IoT device may reduce the probability to access the channel when the previous autonomous transmission was unsuccessful, e.g., a Bernoulli process with a certain probability p whether to access the channel for the given D2R transmission opportunities. The probability may be further scaled back as there are consecutive unsuccessful autonomous D2R transmissions. In further another example, the R2D triggering signal or any R2D signal may provide a probability, p, to access the channel for the following random D2R transmission opportunities. The R2D triggering signal or any R2D signal may also provide backoff indicator providing a parameter related to a random access prohibit timer.

In one embodiment, a certain pre-identified A-IoT device may be assigned a certain slot index from the reader for accessing during the D2R transmission opportunities, which provides contention-free random access.

FIG. 21 illustrates an example device ID structure 2100 according to embodiments of the present disclosure. For example, the device ID structure 2100 can be utilized by an A-IoT device, such as IoT devices 900, 950, 1100, 1150, 1200, or 1250. This example is for illustration only and other embodiments can be used without departing from the scope of the present disclosure.

With reference to FIG. 21, an example device ID structure according to the disclosure is shown.

In one example, the device ID comprises of two parts: the first part indicating a group ID, and the second part indicating a device ID in the group. The device ID as a whole provides a unique device identification.

In some R2D signaling, the device receives a destination ID indicating only the part 1. In this case, if a device identifies that it's group ID matches with the indicated ID, the device decodes the rest of the information in the signal and performs subsequent action, such as R2D data/control reception, D2R data/control transmission, or executing a certain command. In this example, there can be one or more devices with their group ID matched with the indicated ID. Therefore, the one or more devices performs the same action. In some R2D signaling, the device receives a destination ID indicating both the part 1 and the part 2. In this case, a device matching both group ID and the device ID decodes the rest of the information in the signal and performs subsequent action.

The device ID in FIG. 21 may be an assigned ID or an ID associated with the device such as IMEI, EID, IMSI, S-TMSI, or product code such as serial number or a unique ID assigned when the device is deployed.

In another example, the A-IoT device receives two separate IDs, one for the group ID and one for the device ID, respectively. In this case, the second ID provides the unique device identification, independent from the first ID.

In a device identification process, as an example, a device may receive a group ID, either as in FIG. 21 or as a separate ID from a device ID. In this case the devices having the matched group ID only performs the random access for device identification. In this way, the network can control the amount of random access attempts in the presence of a large number of devices in the proximity.

Taking into account the low accuracy clock equipped with an A-IoT devices, the D2R transmission timing can be drifted, which may create interference for D2R multi-access. In one example, an A-IoT device receives a timing correction indication for D2R transmission. The timing correction can be indicated in an absolute value in ms, a basic time unit, symbol, slot, unit clock, or chip. Alternatively, the timing correction can be indicated as an index to a set of predefined values. The correction values can be both negative or positive values, i.e., delay or advance the D2R transmission from current timing.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for an Internet of Things (IoT) device to communicate with a reader, the method comprising:
receiving first one or more physical reader-to-device channels (PRDCHs) from the reader, wherein the reader is a base station or a user equipment (UE) and wherein the first one or more PRDCHs include information related to transmission of a physical device-to-reader channel (PDRCH) including at least one of:
one or more transmission resources,
one or more identifiers corresponding to respective one or more devices,
a group identifier corresponding to one or more devices, and
no identifier corresponding to all devices receiving the first one or more PRDCHs;
determining a first PDRCH based on the information in the first one or more PRDCHs;
transmitting the first PDRCH to the reader based on the information in the first one or more PRDCHs, wherein the first PDRCH is On-Off Keying (OOK) or Phase-Shift Keying (PSK) modulated by backscattering an externally provided carrier wave (CW) or generating the CW internally; and
receiving a second PRDCH from the reader, wherein the second PRDCH includes an acknowledgement of reception of the first PDRCH.

2. The method of claim 1, wherein:
the first one or more PRDCHs further includes a trigger for transmission of the PDRCH,
determining the transmission of the first PDRCH comprises determining the transmission of the first PDRCH based on the trigger and a random selection of a resource in a time or frequency domain from the one or more transmission resources,
transmitting the first PDRCH comprises transmitting the first PDRCH including at least a random number (RN) with a predefined size, and
the second PRDCH includes the RN transmitted in the first PDRCH in the acknowledgement.

3. The method of claim 1, wherein:
the first one or more PRDCHs further includes:
a trigger for transmission of the PDRCH, and
an indication of a transmission resource dedicated to the IoT device,
determining the first PDRCH comprises determining to transmit the first PDRCH based on the trigger, and
the first PDRCH is transmitted on the indicated transmission resource dedicated to IoT the device.

4. The method of claim 1, wherein:
the first one or more PRDCHs further includes a condition for prohibiting a duplicated transmission of the first PDRCH from a same device, and
determining the first PDRCH further comprises:
determining, when the condition is met, not to transmit the duplicated transmission of the first PDRCH to the reader, and
determining, when the condition is not met, to transmit the first PDRCH to the reader.

5. The method of claim 1, further comprising:
transmitting a second PDRCH to the reader including:
a unique device ID associated with the IoT device, or
upper layer data,
wherein the second PRDCH further includes at least one of:
a request for upper layer data,
a transmission timing of the second PDRCH, and
one or more transmission parameters for the second PDRCH.

6. The method of claim 1, wherein:
transmitting the first PDRCH comprises transmitting the first PDRCH including assistance information, and
the assistance information is related to:
an energy status of the IoT device, or
a buffer size.

7. The method of claim 1, wherein:
the first one or more PRDCHs further include a command, and
the one or more identifiers, or the group identifier, are assigned one or more identifiers from the reader.

8. An Internet of Things (IoT) device, comprising:
a transceiver configured to receive first one or more physical reader-to-device channels (PRDCHs) from a reader, wherein the reader is a base station or a user equipment (UE) and wherein the first one or more PRDCHs include information related to transmission of a physical device-to-reader channel (PDRCH) including at least one of:
one or more transmission resources,
one or more identifiers corresponding to respective one or more devices,
a group identifier corresponding to one or more devices, and
no identifier corresponding to all devices receiving the first one or more PRDCHs; and
processing circuitry operably coupled with the transceiver, the processing circuitry configured to determine a first PDRCH based on the information in the first one or more PRDCHs,
wherein the transceiver is further configured to:
transmit the first PDRCH to the reader based on the information in the first one or more PRDCHs, wherein the first PDRCH is On-Off Keying (OOK) or Phase-Shift Keying (PSK) modulated by backscattering an externally provided carrier wave (CW) or generating the CW internally, and
receive a second PRDCH from the reader, wherein the second PRDCH includes an acknowledgement of reception of the first PDRCH.

9. The IoT device of claim 8, wherein:
the first one or more PRDCHs further includes a trigger for transmission of the PDRCH,
the processing circuitry is further configured to determine the first PDRCH based on the trigger and a random selection of a resource in a time or frequency domain from the one or more transmission resources,
the transceiver is further configured to transmit the first PDRCH including at least a random number (RN) with a predefined size, and
the second PRDCH includes the RN transmitted in the first PDRCH in the acknowledgement.

10. The IoT device of claim 8, wherein:
the first one or more PRDCHs further includes:
a trigger for transmission of the PDRCH, and
an indication of a transmission resource dedicated to the IoT device,
the processing circuitry is further configured to determine to transmit the first PDRCH based on the trigger, and
the first PDRCH is transmitted on the indicated transmission resource dedicated to IoT the device.

11. The IoT device of claim 8, wherein:
the first one or more PRDCHs further includes a condition for prohibiting a duplicated transmission of the first PDRCH from a same device, and
the processing circuitry is further configured to:
determine, when the condition is met, not to transmit the duplicated transmission of the first PDRCH to the reader, and
determine, when the condition is not met, to transmit the first PDRCH to the reader.

12. The IoT device of claim 8, wherein:
the transceiver is further configured to transmit a second PDRCH to the reader including:
a unique device ID associated with the IoT device, or
upper layer data, and
the second PRDCH further includes at least one of:
a request for upper layer data,
a transmission timing of the second PDRCH, and
one or more transmission parameters for the second PDRCH.

13. The IoT device of claim 8, wherein:
the transceiver is further configured to transmit the first PDRCH including assistance information, and
the assistance information is related to:
an energy status of the IoT device, or
a buffer size.

14. The IoT device of claim 8, wherein:
the first one or more PRDCHs further include a command, and
the one or more identifiers, or the group identifier, are assigned one or more identifiers from the reader.

15. A reader, comprising:
a transceiver configured to:
transmit first one or more physical reader-to-device channels (PRDCHs) to an Internet of Things (IoT) device, wherein the reader is a base station or a user equipment (UE) and wherein the first one or more PRDCHs include information related to transmission of a physical device-to-reader channel (PDRCH) including at least one of:
one or more transmission resources,
one or more identifiers corresponding to respective one or more devices,
a group identifier corresponding to one or more devices, and
no identifier corresponding to all devices receiving the first one or more PRDCHs;
receive a first PDRCH to the reader based on the information in the first one or more PRDCHs, wherein the first PDRCH is On-Off Keying (OOK) or Phase-Shift Keying (PSK) modulated by backscattering of an externally provided carrier wave (CW) or internal generation of the CW; and
transmit a second PRDCH from the IoT device, wherein the second PRDCH includes an acknowledgement of reception of the first PDRCH.

16. The reader of claim 15, wherein:
the first one or more PRDCHs further includes a trigger for transmission of the PDRCH,
the first PDRCH reception is based on the trigger and a random resource selection in a time or frequency domain from the one or more transmission resources,
the transceiver is further configured to receive the first PDRCH including at least a random number (RN) with a predefined size, and
the second PRDCH includes the RN transmitted in the first PDRCH in the acknowledgement.

17. The reader of claim 15, wherein:
the first one or more PRDCHs further includes:
a trigger for transmission of the PDRCH, and
an indication of a transmission resource dedicated to the IoT device, and
the first PDRCH is received, based on the trigger, on the indicated transmission resource dedicated to IoT the device.

18. The reader of claim 15, wherein:
the first one or more PRDCHs further includes a condition for prohibiting a duplicated transmission of the first PDRCH from a same device,
when the condition is met, the duplicated transmission of the first PDRCH is not received by the reader, and
when the condition is not met, the first PDRCH is received by the reader.

19. The reader of claim 15, wherein:
the transceiver is further configured to receive a second PDRCH from the IoT device including:
a unique device ID associated with the IoT device, or
upper layer data, and
the second PRDCH further includes at least one of:
a request for upper layer data,
a transmission timing of the second PDRCH, and
one or more transmission parameters for the second PDRCH.

20. The reader of claim 15, wherein:
the transceiver is further configured to receive the first PDRCH including assistance information, and
the assistance information is related to:
an energy status of the IoT device, or
a buffer size.
